(19) United States
(12) Patent Application Publication
(10) Pub. No.: US 2003/0174848 A1
(43) Pub. Date: Sep. 18, 2003

(54) Audio receiver system with movable headset plug

(76) Inventor: Ricky L. Hoagland, Portland, OR (US)

Correspondence Address: Ricky L. Hoagland, Cardio Theatre Holdings, Inc., 21420-D NW Nicholas Ct. #12, HIllsboro, OR, 97124, US

(21) Appl. No.: 10/100,414

(22) Filed: Mar. 13, 2002

(51) Int. Cl. H04R 1/10; H04B 3/00; H01R 33/945

(52) U.S. Cl. 381/74; 381/77; 439/577

(57) ABSTRACT

An entertainment receiver system, especially adapted for use on a physical exercise apparatus, is used to combat boredom during exercise sessions. Physical stresses on the housing units are associated with connecting and disconnecting the headset jack of the user's headset into the jack plug on a traditional unit. These stresses can make the unit non-functional. As a solution, a movable headset jack plug is provided external to the housing. The jack plug can be comprised of a flexible cord or a rigid structure movably mounted to the frame by a joint such as a ball and socket. The movable jack plug can be cushioned by a coil spring with the flexible cord or a cushion in the joint of the rigid structure. The movable nature of the jack plug necessitates the user physically holding the plug while they insert their headset jack into the plug. By physically holding the plug and jack, the force applied to the headset jack is equal in magnitude to the reaction force provided by the hand of the user to the plug. This eliminates the forces normally seen by the structure of the housing and electronics stored therein. Upon disconnection, if the user intentionally or inadvertently pulls on the cord of the headset, the jack plug will align to allow disconnection without damage to the system.

### FIELD OF THE INVENTION

The present invention generally relates to audio system receivers. More specifically, the present invention relates to audio receiver systems for use during physical exercise and mounted to an exercise apparatus.

### BACKGROUND OF THE INVENTION

To an ever-increasing degree, exercise is becoming a part of everyday life. One of the biggest deterrents to exercise in general is boredom. This is especially true in health clubs with cardiovascular exercise. In this situation, the user is positioned on a treadmill or other piece of equipment with little other mental stimulation other than watching the time slowly click away until their 20-30 minute exercise session is completed. Few people have the discipline to go the club in the first place. Staring at the wall for 30 minutes while you sweat on yourself exacerbates the lack of motivation many people already have. Forms of entertainment have been added such as watching television or listening to music. In order to encourage membership many clubs have added television screens for the viewing enjoyment of the exerciser. The problem then develops of what to watch. Some prefer sports, others news and still others music videos. To solve this problem clubs install multiple screens with various programming. This allows the user to watch anything from the variety shown. The audio portion of this comes from a low power FM transmitter on each television. Each piece of exercise equipment is then fitted with a receiver that can be tuned in to the various frequencies transmitted. To watch a different show, the user can “change channels” on the audio and look at a different television. Given the physical interaction between the user and the receiver on each machine, the receivers must be made to withstand a fair amount of abuse. These receivers are connected and disconnected to headsets numerous times every day. The fragile nature of electronics and the forceful physical loading of the attachment and detachment make for a potentially destructive combination.

### SUMMARY OF THE INVENTION

In one aspect, the invention features an audio receiver system with a housing with a signal receiver located therein. A headset jack plug is included that is supported by the housing and adapted for movement in at least two degrees of freedom, the plug being in communication with the signal receiver.

The housing of the system may be adapted for mounting onto an exercise apparatus. The signal receiver can be a frequency modulated (FM) receiver or an infrared signal (IR) receiver. Preferably the housing supports the headset jack plug by a flexible extension cord with a first end secured to the housing and a jack plug on the second end. The housing can also support the jack plug by a movable joint, such as a ball and socket joint. This joint may also include a cushion that enables longitudinal movement of the headset jack plug relative to the housing.

The flexible cord can be releasably secured to the housing by way of a support stop that is received by a recess in the housing, and secured by an access door. The flexible extension cord may include a spring coil positioned between the first end and the second end of the cord. In another aspect, the invention includes a method of providing audio entertainment during physical exercise including the steps of: providing a physical exercise apparatus, an audio receiver system, a portion of which is mounted to said exercise apparatus, the system including a system as previously disclosed and an audio headset with a jack. The user then grasps the headset jack plug and the jack of the audio headset simultaneously and inserts the jack into the plug

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is an isometric view of an audio receiver system without a movable headset mount, as was formally used in the art.

FIG. 2 is a side view of an audio receiver system shown in accordance with the prior art, and as it would typically be used on an exercise apparatus.

FIG. 3 is an isometric view of an audio receiver system with a movable headset mount shown in an assembled state and in produced accordance with the preferred embodiment of the present invention.

FIG. 4 is an isometric view of an audio receiver system with a movable headset mount shown in a partially disassembled state and produced in accordance with the preferred embodiment of the present invention.

FIG. 5 is an isometric view of an audio receiver system with a movable headset mount shown in a disassembled state and produced in accordance with the preferred embodiment of the present invention.

FIG. 6 is an isometric view of an audio receiver system with a movable headset mount shown as it would typically be used on an exercise apparatus and produced in accordance with the preferred embodiment of the present invention.

FIG. 7 is an isometric view of an audio receiver system with a movable headset mount shown in an assembled state and produced in accordance with an alternative to the preferred embodiment of the present invention.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

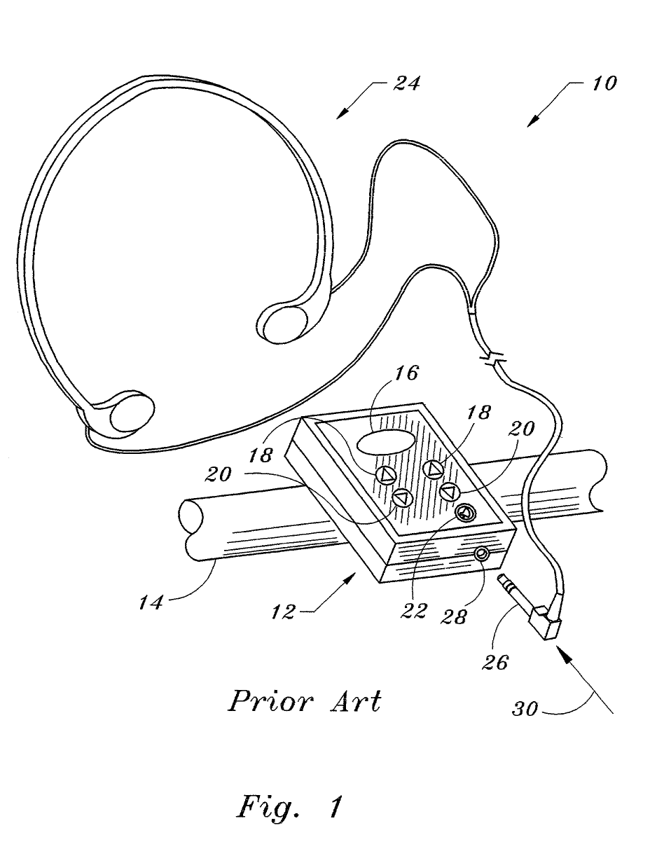

The present invention is an audio receiver system with movable headset plug and method that reduces stress on the housing and electronic components of the system. Referring to the drawings, FIG. 1 shows a prior art system 10. The housing 12 is attached to a structure of a piece of exercise equipment 14. This is typically easily accessible to the user both by touch and sight while using the apparatus 14. Common forms of equipment are a treadmill, stepper, bike or other cardiovascular training equipment. Strength training equipment can also be used, but due to the prolonged periods of time the user is on a piece of cardiovascular piece of equipment as compared to cardiovascular equipment, being entertained during the cardiovascular exercise is more advantageous.

The system includes a display 16 to offer visual cues to the user. This is typically a particular channel to which the unit is tuned, but could be any form of visual instruction or information. In the preferred embodiment, this is a liquid crystal display (LCD) or in some cases a light emitted diode (LED) used as an array of seven segment elements. Two pair of buttons, two up 18 and two down 20 are located on the face of the housing 12 to allow input of channel and volume control. A mute button 22 is also provided to shut off the sound if desired. The housing also includes a radio frequency (RF) receiver or an infrared signal (IR) receiver. Transmitters are located within the required range to allow for signal transmission and reception by the unit.

The audio signal is then transferred to the user's ears by way of a headset 24. The headset 24 includes a headset jack 26 that is inserted into the headset jack plug 28 located within the housing 12 of the unit 10. The jack 26 is inserted into the plug 28 by pushing on the jack 26 as depicted by the arrow 30. Users commonly provide excessive force during this “assembly” process. Since the housing 12 is mounted to the frame of the exercise device 14, the user need only jam the jack 26 in the plug 28 using one hand. Excessive load is transferred to the unit 10, and particularly the circuit boards housed within the unit 10. A single excessive force or multiple mildly excessive forces can result in a damaged or disabled system 10. This renders the device unserviceable and must then be replaced.

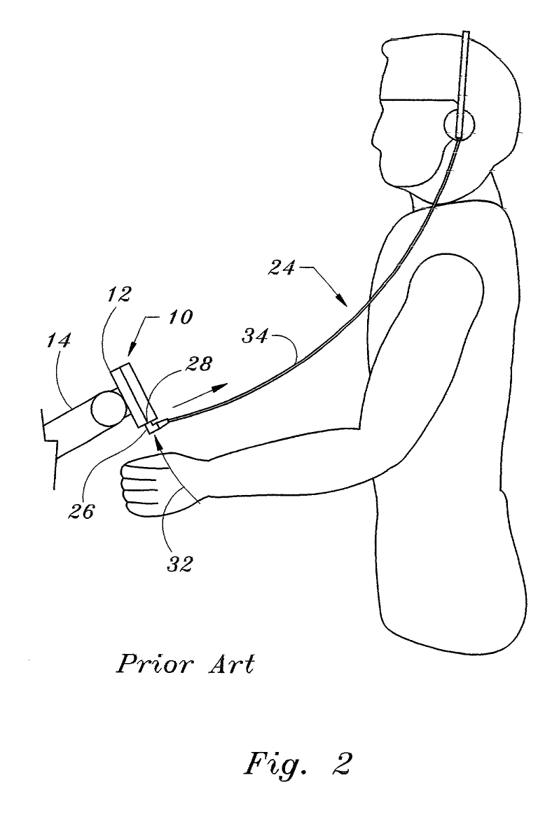

Another common form of damage can occur due to unintentional or accidental structural loading of the system 10 in the disconnection of the jack 26 from the plug 28. This is illustrated in FIG. 2. Here again, a prior art version of the device is shown, as it would be attached to a frame member of a piece of exercise equipment 14. The jack 26 is inserted into the unit 10 as depicted by the arrow 32. The cord 34 of the headset 24 is typically a braded metal with an insulating cover. This combination has the ability to provide over one hundred pounds of tensile force before the cord 34 would fail. If the user inadvertently pulls away from the unit 10 without first disconnecting the card by error or accident, this load would be transferred to the unit, potentially damaging it.

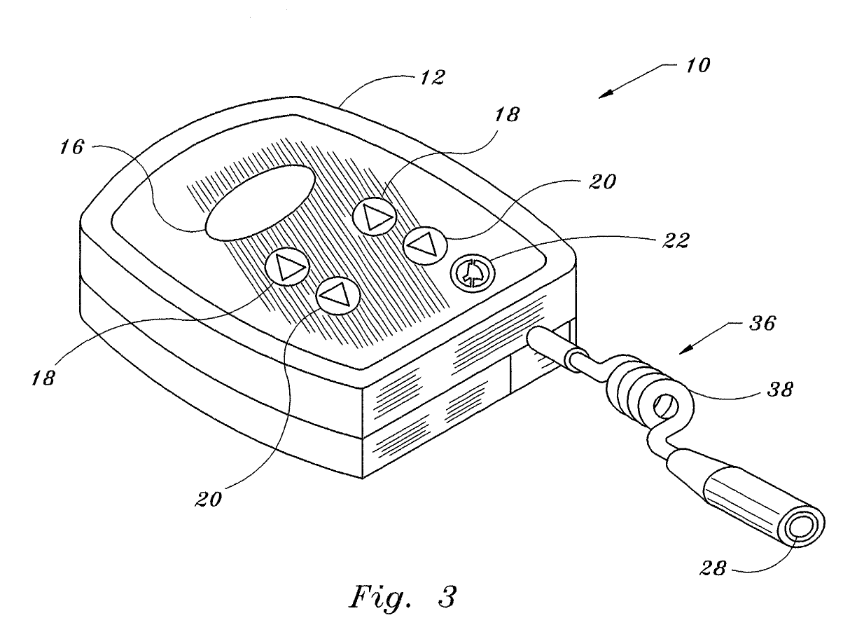

I FIG. 3, a novel improvement has been made by use of a spring cord 36 that is attached to the housing 12. The same display 16 and arrangement of buttons (18, 20 & 22) are used as described in the prior art. The spring cord provides a tether from the headset jack plug 28 and the rest of the unit located within the housing 12. This provides a free range of motion of at least 2 degrees of freedom relative to the housing 12. The spring portion 38 of the spring cord 36 allows the plug 28 to also move longitudinally closer to and away from the housing while eliciting only minor forces in the housing.

The value of this is several fold. First, in order to assemble a jack of a headset into the unit, the user must hold the jack plug 28 on the free end of the cord 36. By physically holding this part, any compressive forces used in the assembly are not transmitted to the housing 12, and therefore to the electronics enclosed therein. Second, the jack plug is able to move freely in an infinite number of positions. Therefore, any accidental detachment by pulling the jack of the headset out of the jack plug 28, the flexible nature of the spring cord 36 will allow the jack plug to align and disassemble without damage to the unit. Finally, the spring portion 38 provides a cushion, which absorbs tensile loads placed on the cord 36, thereby reducing stress to the electronics and structure of the unit.

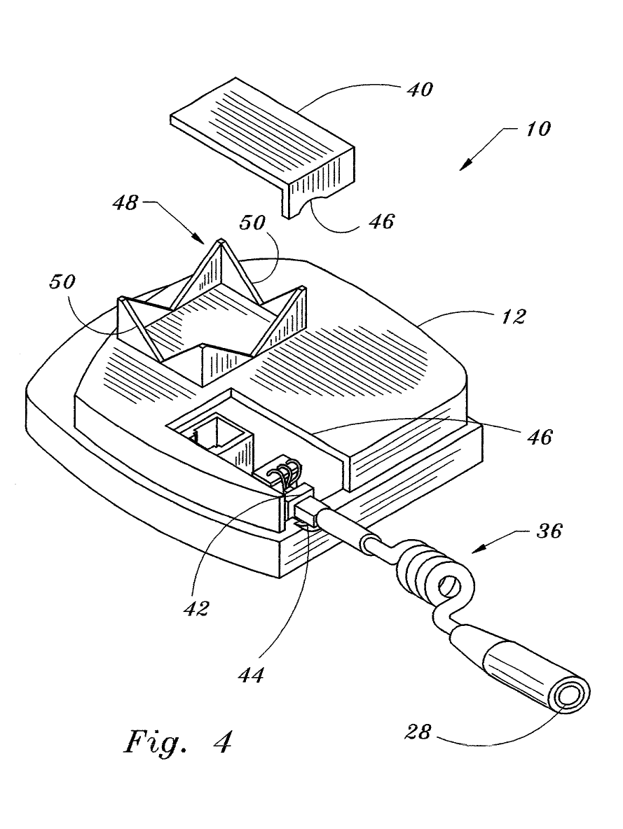

The unit 10 is also shown in FIG. 4 inverted with the access door 40 removed. The removal of the door 40 shows the mode of attachment of the spring cord 36. At the base of the spring cord 36, which is attached to the housing 12 by way of a support stop 42. The support stop 42 is received by a recess 44 in the base of the housing 12. A second recess 46 is positioned in the access door 40. When the access door 40 is positioned on the housing 12 over the opening 46, the spring cord is locked in place in that it is secured to the housing 12. A mounting bracket 48 is mounted to or a part of the housing 12. The grooves in the mounting bracket 50 allow for the unit to nest to a portion of a frame of an exercise device.

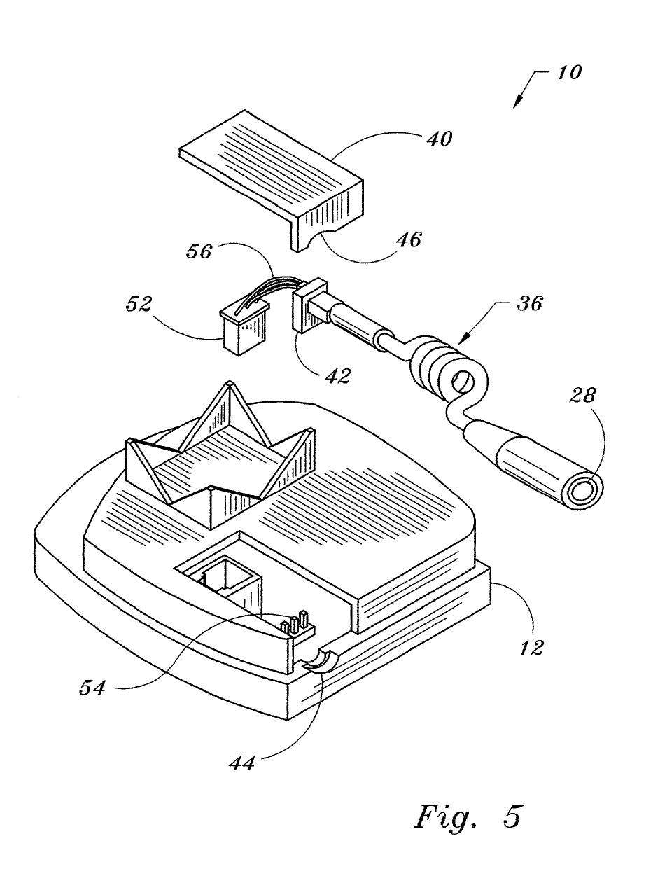

An exploded view of the device 10 shown inverted is depicted in greater detail in FIG. 5. In this view, the spring cord 36 has been removed from the housing 12. At the opposite end of the spring cord 36 relative to the jack plug 28, is a board plug 52. The board plug 52 provides communication from the jack plug 28 to the unit 10 by way of the board pin 54. The flexible connectors 56 between the support stop 42 and the board plug 52 allow assembly of the board plug 52 to the board pin 54 before or after seating the support stop 42 in the recess 44. This combination virtually eliminates tension loads between the jack plug 28 and the electronics within the housing 12.

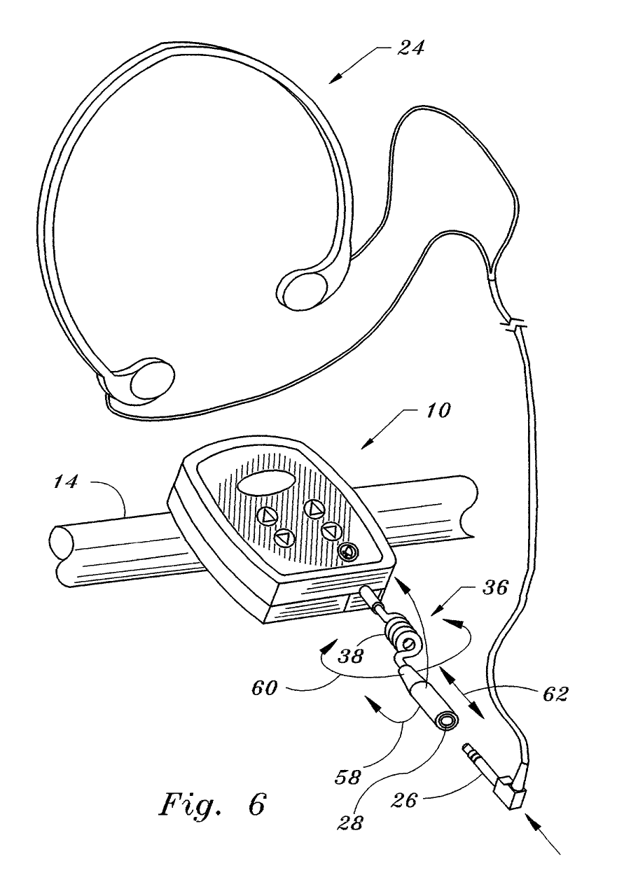

The freedom of movement is illustrated in FIG. 6. Here the unit 10 is shown, as it would typically be used on a frame member 14 of a piece of exercise equipment. The headset 24 includes a jack 26 that is received by the jack plug 28. The vertical axis arrow 58 and the horizontal axis arrow 60 show the freedom of movement of the jack plug 28 throughout these two degrees of freedom. The linear arrow 62 shows depicts the movement through a third degree of freedom as permitted by the spring portion 38 of the spring cord 36 and the general flexibility of the cord 36.

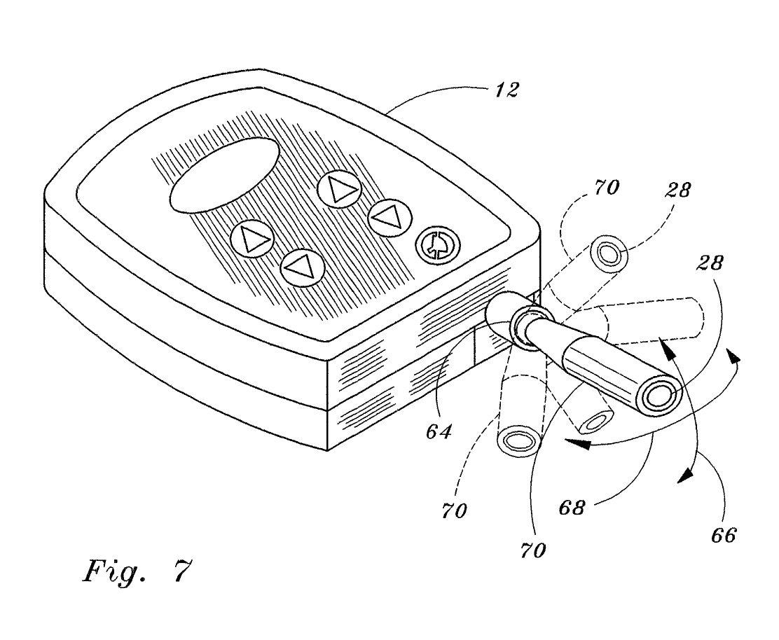

Another version of the device is shown in FIG. 7. Here, a movable jack plug 28 that is mounted to the housing 12 by way of a joint 64 has replaced the flexible cord. This socket is shown to be a ball and socket joint that allows free movement through the vertical plane, as depicted by the vertical arrow 66, and the horizontal plane as depicted by the horizontal arrow 68. The ball can be fitted with a compressible material cushion to absorb stress from the assembly of the jack 26 (not shown) into the plug 28. The material that makes up the plug housing 70 can also be made of a pliable material to damp loads placed on the system during assembly with the jack. As previously disclosed, the plug 28 can freely move in at least two degrees of freedom, thus allowing automatic alignment during disconnection and necessitating a grasping both the plug 28 and the jack during assembly of these parts. This greatly reduces the stress to the structure of the housing and electronics housed therein, increasing the durability of field life of the device.

What is claimed is:

1. An audio receiver system comprising:
a housing with a signal receiver located therein; and
a headset jack plug supported by, and external to said housing and adapted for movement in at least two degrees of freedom, the plug in communication with said signal receiver.

2. A system as in claim 1, wherein said housing is adapted for mounting onto an exercise apparatus.

3. A system as in claim 1, wherein said signal receiver is a frequency modulated (FM) receiver.

4. A system as in claim 1, wherein said signal receiver is an infrared signal (IR) receiver.

5. A system as in claim 1, wherein said headset jack plug is supported by said housing by a flexible extension cord with a first end secured to said housing and a second end including said jack plug.

6. A system as in claim 5, wherein said flexible extension cord is releasably secured to said housing.

7. A system as in claim 6, wherein said cord is releasably secured by way of a support stop that is received by a recess in said housing, and secured by an access door.

8. A system as in claim 5, wherein said flexible extension cord includes a spring coil.

9. A system as in claim 8, wherein said spring coil is positioned between said first end and said second end of said cord.

10. A system as in claim 8, wherein said flexible extension cord is releasably secured to said housing.

11. A system as in claim 10, wherein said cord is releasably secured by way of a support stop that is received by a recess in said housing, and secured by an access door.

12. A system as in claim 1, wherein said headset jack plug is supported by said housing by a movable joint.

13. A system as in claim 12, wherein said movable joint is a ball in socket joint.

14. A system as in claim 12, wherein said movable joint includes a cushion to said housing, thereby enabling longitudinal movement of said headset jack plug relative to said housing.

15. An entertainment receiver box for an exercise apparatus comprising:
a housing with a signal receiver located therein; and
a headset jack plug supported by said housing and adapted for movement in at least two degrees of freedom, the plug in communication with said signal receiver.

16. A system as in claim 15, wherein said signal receiver is a frequency modulated (FM) receiver.

17. A system as in claim 15, wherein said signal receiver is an infrared signal (IR) receiver.

18. A system as in claim 15, wherein said headset jack plug is supported by said housing by a flexible extension cord with a first end secured to said housing and a second end including said jack plug.

19. A system as in claim 18, wherein said flexible extension cord is releasably secured to said housing.

20. A system as in claim 19, wherein said cord is releasably secured by way of a support stop that is received by a recess in said housing, and secured by an access door.

21. A system as in claim 18, wherein said flexible extension cord includes a spring coil.

22. A system as in claim 21, wherein said spring coil is positioned between said first end and said second end of said cord.

23. A system as in claim 21, wherein said flexible extension cord is releasably secured to said housing.

24. A system as in claim 23, wherein said cord is releasably secured by way of a support stop that is received by a recess in said housing, and secured by an access door.

25. A system as in claim 15, wherein said headset jack plug is supported by said housing by a movable joint.

26. A system as in claim 25, wherein said movable joint is a ball in socket joint.

27. A system as in claim 25, wherein said movable joint includes a cushion to said housing, thereby enabling longitudinal movement of said headset jack plug relative to said housing.

28. A method of receiving audio entertainment during physical exercise including the steps of:
providing a physical exercise apparatus;
providing an audio receiver system, a portion of which is mounted to said exercise apparatus, the system including:
a housing with a signal receiver located therein; and
a headset jack plug supported by said housing and adapted for movement in at least two
degrees of freedom, the plug in communication with said signal receiver;
providing an audio headset with a jack; and
grasping said headset jack plug and said jack of said audio headset simultaneously and inserting said jack into said plug.
